(19) United States
(12) Patent Application Publication
(10) Pub. No.: US 2022/0353949 A1
(43) Pub. Date: Nov. 3, 2022

(54) METHOD AND APPARATUS FOR HANDLING MEASUREMENT CONFIGURATION IN A WIRELESS COMMUNICATION SYSTEM

(71) Applicant: ASUSTek Computer Inc., Taipei City 112 (TW)

(72) Inventors: Yi-Hsuan Huang, Taipei City (TW); Meng-Hui Ou, Taipei City (TW)

(21) Appl. No.: 17/724,763

(22) Filed: Apr. 20, 2022

Related U.S. Application Data
(60) Provisional application No. 63/181,882, filed on Apr. 29, 2021.

(51) Int. Cl. H04W 76/30; H04W 24/10

(52) U.S. Cl. CPC H04W 76/30; H04W 24/10; H04W 84/06

(57) ABSTRACT

Methods and apparatuses are provided for a User Equipment (UE) to determine the value of a parameter, such as a timeToTrigger, a reportOnLeave, a useWhiteCellList, etc., when the measurement reporting procedure is associated with multiple triggering events. For example, a UE can receive a measurement configuration comprising a combined triggering condition of a first triggering event and a second triggering event, trigger a first measurement report in response to fulfilment of an entering condition of the first triggering event and an entering condition of the second triggering event, and trigger a second measurement report in response to fulfilment of one of a leaving condition of the first triggering event and a leaving condition of the second triggering event, if at least a first parameter for the first triggering event or for the second triggering event is set to TRUE.

### CROSS-REFERENCE TO RELATED APPLICATIONS

The present application claims priority to and the benefit of U.S. Provisional Patent Application Ser. No. 63/181,882, filed Apr. 29, 2021, which is fully incorporated herein by reference.

### FIELD

This disclosure generally relates to wireless communication networks and, more particularly, to a method and apparatus for handling measurement configurations in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling measurement configurations in a wireless communication system. A User Equipment (UE) determines the value of a parameter, such as a timeToTrigger, a reportOnLeave, a useWhiteCellList, etc., when the measurement reporting procedure is associated with multiple triggering events.

In various embodiments, with this and other concepts, systems, and methods of the present invention, a method of a Network (NW) comprises configuring multiple triggering events, at least a first triggering event and a second triggering event, as a combined triggering condition in a measurement configuration, configuring a first parameter, a second parameter, and/or a third parameter associated to the combined triggering condition in the measurement configuration.

In various embodiments, with this and other concepts, systems, and methods of the present invention, a method of a UE comprises receiving multiple triggering events, with at least a first triggering event and a second triggering event, as a combined triggering condition in a measurement configuration, and receiving a first parameter, a second parameter, and/or a third parameter associated to the combined triggering condition in the measurement configuration.

In various embodiments, with this and other concepts, systems, and methods of the present invention, a method of a UE comprises receiving a measurement configuration comprising a combined triggering condition of a first triggering event and a second triggering event, triggering a first measurement report in response to fulfilment of an entering condition of the first triggering event and an entering condition of the second triggering event, and triggering a second measurement report in response to fulfilment of one of a leaving condition of the first triggering event and a leaving condition of the second triggering event, if at least a first parameter for the first triggering event or for the second triggering event is set to TRUE.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a first example related to a reportOnLeave parameter, wherein the UE may trigger a measurement report when the leaving condition for the first triggering event is met at the first timing and trigger another measurement report when the leaving condition for the second triggering event is met at the second timing, in accordance with embodiments of the present invention.

FIG. 6 is a second example related to a reportOnLeave parameter, wherein the second parameter (e.g., reportOnLeave) for the first triggering event is set to TRUE and the second parameter for the second triggering event is set to FALSE, in accordance with embodiments of the present invention.

FIG. 7 is a third example related to a reportOnLeave parameter, wherein if the second parameter (e.g., reportOnLeave) for one of the events (e.g., the first triggering event) is set to TRUE, the UE may trigger a measurement report when the leaving condition for the first triggering event is met (possibly the entering condition for the first triggering event has been met), in accordance with embodiments of the present invention.

FIG. 8 is a fourth example related to a reportOnLeave parameter, wherein once the measurement report has been triggered due to one of the leaving conditions having been met, the UE may not trigger a measurement report if the leaving condition for both the first triggering event and the second triggering event have been met, in accordance with embodiments of the present invention.

FIG. 9 is a first example of a measurement configuration, wherein the triggering events in eventId are the triggering events based on cell quality, the triggering events in eventId-Loc are the triggering events based on UE location, and the NW may configure one of the triggering events based on cell quality and/or one of the triggering events based on UE location in the measurement configuration, in accordance with embodiments of the present invention.

FIG. 10 is A second example of a measurement configuration, wherein the triggering events in eventId are the triggering events based on cell quality, the triggering events in eventId-Loc are the triggering events based on UE location, and the NW may configure one of the triggering events based on cell quality and/or one of the triggering events based on UE location in the measurement configuration, in accordance with embodiments of the present invention.

FIG. 11 (11A-11B) is a third example of a measurement configuration, wherein the NW may configure a list of (e.g., one or multiple) triggering events in eventList in the measurement configuration, in accordance with embodiments of the present invention.

FIG. 12 is a fourth example of a measurement configuration, wherein the triggering events in eventId are the triggering events based on cell quality, the triggering events in eventId-Loc are the triggering events based on UE location, and the NW may configure one of the triggering events based on cell quality and/or one of the triggering events based on UE location in the measurement configuration, in accordance with embodiments of the present invention.

FIG. 13 is a flow diagram of a method of a NW configuring multiple triggering events, in accordance with embodiments of the present invention.

FIG. 14 is a flow diagram of a method of a UE receiving multiple triggering events, in accordance with embodiments of the present invention.

FIG. 15 is a flow diagram of a method of a UE receiving a measurement configuration and triggering first and second measurement reports, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-201256, “Solutions for NR to support non-terrestrial networks (NTN)”; [2] 3GPP TS 38.331 V16.4.1, “NR, RRC protocol specification”; and [3] 3GPP TR 38.821 V16.0.0, “Solutions for NR to support non-terrestrial networks (NTN)”. The standards and documents listed above are hereby expressly and fully incorporated herein by reference in their entirety.

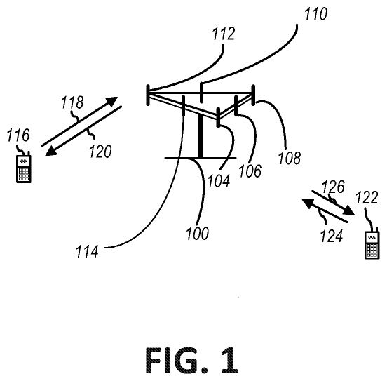

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

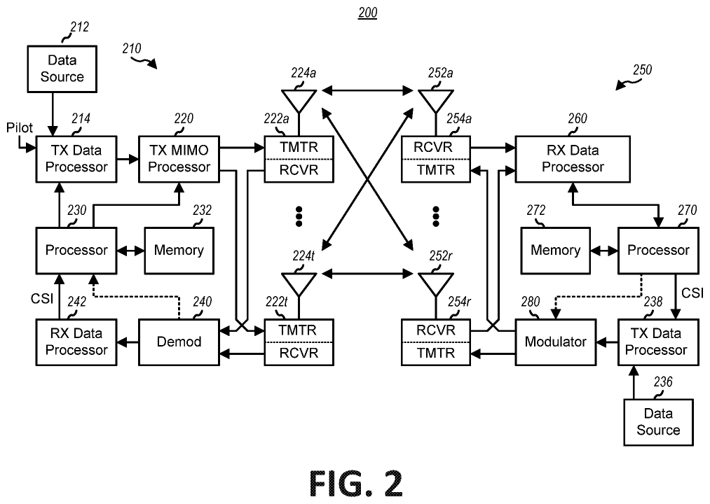

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

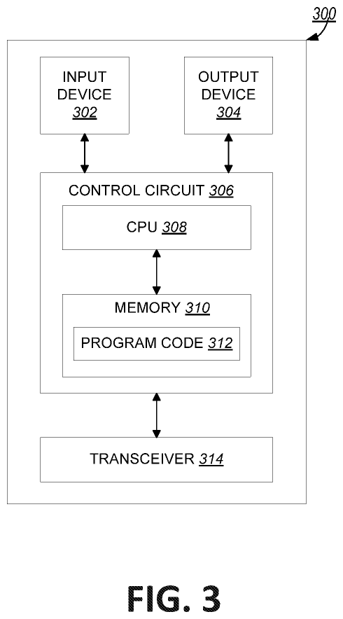

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

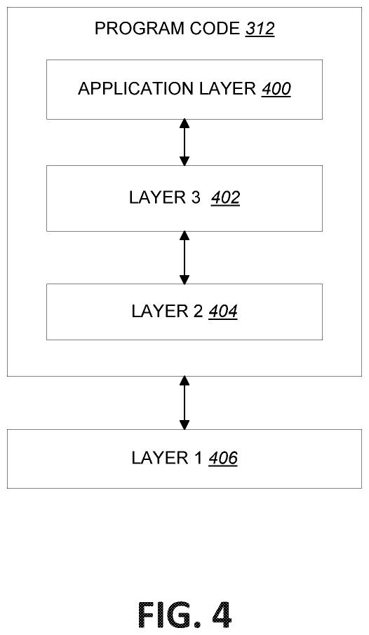

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention may be combined logically, reasonably, and properly to form a specific method.

Any sentence, paragraph, (sub-)bullet, point, action, or claim described in each of the following invention may be implemented independently and separately to form a specific method. Dependency, e.g., “based on”, “more specifically”, etc., in the following invention is just one possible embodiment which would not restrict the specific method.

The work item of non-terrestrial networks (NTN) in NR has been approved in RAN plenary #88 meeting. The description of the work item is specified in [1] RP-201256:

### ************************************** Quotation Start [1] **********************************

### 3 Justification

Non-terrestrial networks refer to networks, or segments of networks, using an airborne or spaceborne vehicle for transmission:
Spaceborne vehicles: Satellites (including Low Earth Orbiting (LEO) satellites, Medium Earth Orbiting (MEO) satellites, Geostationary Earth Orbiting (GEO) satellites as well as Highly Elliptical Orbiting (HEO) satellites) Airborne vehicles: High Altitude Platforms (HAPs) encompassing Unmanned Aircraft Systems (UAS) including
Lighter than Air UAS (LTA), Heavier than Air UAS (HTA), all operating in altitudes typically between 8 and 50 km, quasi-stationary.
   . . .
   Based on the above points, a new work item is proposed to carry the conclusion of the FS_NR_NTN_solutions study item and specify the solutions enabling NR to support non-terrestrial networks.
   Addressing LEO and GEO scenarios will enable to support all NGSO scenarios with circular orbit at altitude greater than or equal to 600 km.

### 4 Objective

### 4.1 Objective of SI or Core Part WI or Testing Part WI

The work item aims to specify the enhancements identified for NR NTN (non-terrestrial networks) especially LEO and GEO with implicit compatibility to support HAPS (high altitude platform station) and ATG (air to ground) scenarios according to the following principles:
FDD is assumed for core specification work for NR-NTN.
   NOTE: This does not imply that TDD cannot be used for relevant scenarios e.g. HAPS, ATG
Earth fixed Tracking area is assumed with Earth fixed and moving cells
UEs with GNSS capabilities are assumed.
Transparent payload is assumed

### ************************************** Quotation End **************************************

The measurement report and triggering events are specified in TS 38.331 [2] as below:

### ************************************** Quotation Start [2] **********************************

### 5.5 Measurements

### 5.5.1 Introduction

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.
The network may configure the UE to perform the following types of measurements:
NR measurements;
Inter-RAT measurements of E-UTRA frequencies.
Inter-RAT measurements of UTRA-FDD frequencies.
   The network may configure the UE to report the following measurement information based on SS/PBCH block(s):
Measurement results per SS/PBCH block;
Measurement results per cell based on SS/PBCH block(s);
SS/PBCH block(s) indexes.
   The network may configure the UE to report the following measurement information based on CSI-RS resources:
Measurement results per CSI-RS resource;
Measurement results per cell based on CSI-RS resource(s);
CSI-RS resource measurement identifiers.
   The network may configure the UE to perform the following types of measurements for sidelink
CBR measurements.
   The network may configure the UE to report the following CLI measurement information based on SRS resources:
Measurement results per SRS resource;
SRS resource(s) indexes.
   The network may configure the UE to report the following CLI measurement information based on CLI-RSSI resources:
Measurement results per CLI-RSSI resource;
CLI-RSSI resource(s) indexes.
   The measurement configuration includes the following parameters:
1. Measurement objects: A list of objects on which the UE shall perform the measurements.
   For intra-frequency and inter-frequency measurements a measurement object indicates the frequency/time location and subcarrier spacing of reference signals to be measured. Associated with this measurement object, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
   The measObjectId of the MO which corresponds to each serving cell is indicated by servingCellMO within the serving cell configuration.
   For inter-RAT E-UTRA measurements a measurement object is a single E-UTRA carrier frequency. Associated with this E-UTRA carrier frequency, the network can configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
   For inter-RAT UTRA-FDD measurements a measurement object is a set of cells on a single UTRA-FDD carrier frequency.
   For CBR measurement of NR sidelink communication, a measurement object is a set of transmission resource pool(s) on a single carrier frequency for NR sidelink communication.
   For CLI measurements a measurement object indicates the frequency/time location of SRS resources and/or CLI-RSSI resources, and subcarrier spacing of SRS resources to be measured.
2. Reporting configurations: A list of reporting configurations where there can be one or multiple reporting configurations per measurement object. Each measurement reporting configuration consists of the following:
   Reporting criterion: The criterion that triggers the UE to send a measurement report. This can either be periodical or a single event description.
   RS type: The RS that the UE uses for beam and cell measurement results (SS/PBCH block or CSI-RS).
   Reporting format: The quantities per cell and per beam that the UE includes in the measurement report (e.g. RSRP) and other associated information such as the maximum number of cells and the maximum number beams per cell to report.
In case of conditional reconfiguration, each configuration consists of the following:
   Execution criteria: The criteria the UE uses for conditional reconfiguration execution.
   RS type: The RS that the UE uses for obtaining beam and cell measurement results (SS/PBCH block-based or CSI-RS-based), used for evaluating conditional reconfiguration execution condition.
3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.
4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.
5. Measurement gaps: Periods that the UE may use to perform measurements.
   A UE in RRC_CONNECTED maintains a measurement object list, a reporting configuration list, and a measurement identities list according to signalling and procedures in this specification. The measurement object list possibly includes NR measurement object(s), CLI measurement object(s) and inter-RAT objects. Similarly, the reporting configuration list includes NR and inter-RAT reporting configurations. Any measurement object can be linked to any reporting configuration of the same RAT type. Some reporting configurations may not be linked to a measurement object. Likewise, some measurement objects may not be linked to a reporting configuration.
   The measurement procedures distinguish the following types of cells:
1. The NR serving cell(s)—these are the SpCell and one or more SCells.
2. Listed cells—these are cells listed within the measurement object(s).
3. Detected cells—these are cells that are not listed within the measurement object(s) but are detected by the UE on the SSB frequency(ies) and subcarrier spacing(s) indicated by the measurement object(s).
   For NR measurement object(s), the UE measures and reports on the serving cell(s), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources).

### ************************************** Next Quotation *************************************

### 5.5.4 Measurement Report Triggering

### 5.5.4.1 General

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the corresponding reportConfig includes measRSSI-ReportConfig:
         5> consider the resource indicated by the rmtc-Config on the associated frequency to be applicable;
         4> if the eventA1 or eventA2 is configured in the corresponding reportConfig:
         5> consider only the serving cell to be applicable;
         4> if the eventA3 or eventA5 is configured in the corresponding reportConfig:
         5> if a serving cell is associated with a measObjectNR and neighbours are associated with another measObjectNR, consider any serving cell associated with the other measObjectNR to be a neighbouring cell as well;
         4> if corresponding reportConfig includes reportType set to periodical; or
         4> for measurement events other than eventA1 or eventA2:
         5> if useWhiteCellList is set to true:
         6> consider any neighbouring cell detected based on parameters in the associated measObjectNR to be applicable when the concerned cell is included in the whiteCellsToAddModList defined within the VarMeasConfig for this measId;
         5> else:
         6> consider any neighbouring cell detected based on parameters in the associated measObjectNR to be applicable when the concerned cell is not included in the blackCellsToAddModList defined within the VarMeasConfig for this measId;
      [ . . . ]
   2> if the reportType is set to eventTriggered and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      3> include a measurement reporting entry within the VarMeasReportList for this measId;
      3> set the numberOfReportsSent defined within the VarMeasReportList for this measId to 0;
      3> include the concerned cell(s) in the cellsTriggeredList defined within the VarMeasReportList for this measId;
      3> if use T312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> else if the reportType is set to eventTriggered and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
      3> set the numberOfReportsSent defined within the VarMeasReportList for this measId to 0;
      3> include the concerned cell(s) in the cellsTriggeredList defined within the VarMeasReportList for this measId;
      3> if use T312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> else if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
      3> remove the concerned cell(s) in the cellsTriggeredList defined within the VarMeasReportList for this measId;
      3> if reportOnLeave is set to true for the corresponding reporting configuration:
         4> initiate the measurement reporting procedure, as specified in 5.5.5;
      3> if the cellsTriggeredList defined within the VarMeasReportList for this measId is empty:
         4> remove the measurement reporting entry within the VarMeasReportList for this measId;
         4> stop the periodical reporting timer for this measId, if running;
   2> else if the reportType is set to eventTriggered and if the entry condition applicable for this event, i.e. the event corresponding with the eventId of the corresponding reportConfig within VarMeasConfig, is fulfilled for one or more applicable transmission resource pools for all measurements taken during timeToTrigger defined for this event within the VarMeasConfig, while the VarMeasReportList does not include an measurement reporting entry for this measId (a first transmission resource pool triggers the event):
      3> include a measurement reporting entry within the VarMeasReportList for this measId;
      3> set the numberOfReportsSent defined within the VarMeasReportList for this measId to 0;
      3> include the concerned transmission resource pool(s) in the poolsTriggeredList defined within the VarMeasReportList for this measId;
      3> initiate the measurement reporting procedure, as specified in 5.5.5;
   2> else if the reportType is set to eventTriggered and if the entry condition applicable for this event, i.e. the event corresponding with the eventId of the corresponding reportConfig within VarMeasConfig, is fulfilled for one or more applicable transmission resource pools not included in the poolsTriggeredList for all measurements taken during timeToTrigger defined for this event within the VarMeasConfig (a subsequent transmission resource pool triggers the event):
      3> set the numberOfReportsSent defined within the VarMeasReportList for this measId to 0;
      3> include the concerned transmission resource pool(s) in the poolsTriggeredList defined within the VarMeasReportList for this measId;
      3> initiate the measurement reporting procedure, as specified in 5.5.5;
   2> else if the reportType is set to eventTriggered and if the leaving condition applicable for this event is fulfilled for one or more applicable transmission resource pools included in the poolsTriggeredList defined within the VarMeasReportList for this measId for all measurements taken during timeToTrigger defined within the VarMeasConfig for this event:
      3> remove the concerned transmission resource pool(s) in the poolsTriggeredList defined within the VarMeasReportList for this measId;
      3> if the poolsTriggeredList defined within the VarMeasReportList for this measId is empty:
         4> remove the measurement reporting entry within the VarMeasReportList for this measId;
         4> stop the periodical reporting timer for this measId, if running
   [ . . . ]
      5.5.4.2 Event A1 (Serving Becomes Better than Threshold)
      The UE shall:
1> consider the entering condition for this event to be satisfied when condition A1-1, as specified below, is fulfilled;
1> consider the leaving condition for this event to be satisfied when condition A1-2, as specified below, is fulfilled;
1> for this measurement, consider the NR serving cell corresponding to the associated measObjectNR associated with this event.

Ms−Hys>Thresh Inequality A1-1 (Entering condition)

Ms+Hys<Thresh Inequality A1-2 (Leaving condition)

[ . . . ]
5.5.4.3 Event A2 (Serving Becomes Worse than Threshold)
The UE shall:
1> consider the entering condition for this event to be satisfied when condition A2-1, as specified below, is fulfilled;
1> consider the leaving condition for this event to be satisfied when condition A2-2, as specified below, is fulfilled;
1> for this measurement, consider the serving cell indicated by the measObjectNR associated to this event.

Ms+Hys<Thresh Inequality A2-1 (Entering condition)

Ms−Hys>Thresh Inequality A2-2 (Leaving condition)

[ . . . ]
5.5.4.4 Event A3 (Neighbour Becomes Offset Better than SpCell)
The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.
NOTE 1: The cell(s) that triggers the event has reference signals indicated in the measObjectNR associated to this event which may be different from the NR SpCell measObjectNR.

Mn+Ofn+Ocn−Hys>Mp+Ofp+Ocp+Off Inequality A3-1 (Entering condition)

Mn+Ofn+Ocn+Hys<Mp+Ofp+Ocp+Off Inequality A3-2 (Leaving condition)

[ . . . ]
NOTE 2: The definition of Event A3 also applies to CondEvent A3.
   5.5.4.5 Event A4 (Neighbour Becomes Better than Threshold)
   The UE shall:
1> consider the entering condition for this event to be satisfied when condition A4-1, as specified below, is fulfilled;
1> consider the leaving condition for this event to be satisfied when condition A4-2, as specified below, is fulfilled.

Mn+Ofn+Ocn—Hys>Thresh Inequality A4-1 (Entering condition)

Mn+Ofn+Ocn+Hys<Thresh Inequality A4-2 (Leaving condition)

[ . . . ]
5.5.4.6 Event A5 (SpCell Becomes Worse than Threshold1 and Neighbour Becomes Better than Threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.
NOTE 1: The parameters of the reference signal(s) of the cell(s) that triggers the event are indicated in the measObjectNR associated to the event which may be different from the measObjectNR of the NR SpCell.

Mp+Hys<Thresh1 Inequality A5-1 (Entering condition 1)

Mn+Ofn+Ocn—Hys>Thresh2 Inequality A5-2 (Entering condition 2)

Mp—Hys>Thresh1 Inequality A5-3 (Leaving condition 1)

Mn+Ofn+Ocn+Hys<Thresh2 Inequality A5-4 (Leaving condition 2)

[ . . . ]
NOTE 2: The definition of Event A5 also applies to CondEvent A5.
   5.5.4.7 Event A6 (Neighbour Becomes Offset Better than SCell)
   The UE shall:
1> consider the entering condition for this event to be satisfied when condition A6-1, as specified below, is fulfilled;
1> consider the leaving condition for this event to be satisfied when condition A6-2, as specified below, is fulfilled;
1> for this measurement, consider the (secondary) cell corresponding to the measObjectNR associated to this event to be the serving cell.
NOTE: The reference signal(s) of the neighbour(s) and the reference signal(s) of the SCell are both indicated in the associated measObjectNR.

Mn+Ocn−Hys>Ms+Ocs+Off Inequality A6-1 (Entering condition)

Mn+Ocn+Hys<Ms+Ocs+Off Inequality A6-2 (Leaving condition)

### ************************************** Quotation End **************************************

The measurement triggering events could be configured by RRC, as specified in TS 38.331 [2] as below:

### ************************************** Quotation Start [2] **********************************

ReportConfigNR

The IE ReportConfigNR specifies criteria for triggering of an NR measurement reporting event or of a CHO or CPC event. For events labelled AN with N equal to 1, 2 and so on, measurement reporting events and CHO or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
CondEvent A3: Conditional reconfiguration candidate becomes amount of offset better than PCell/PSCell;
CondEvent A5: PCell/PSCell becomes worse than absolute threshold1 AND Conditional reconfiguration candidate becomes better than another absolute threshold2;

| | |
|---|---|
| [...] | |
| | ReportConfigNR information element |
| ReportConfigNR ::= | SEQUENCE { |
| reportType | CHOICE { |
| periodical | PeriodicalReportConfig, |
| eventTriggered | EventTriggerConfig, |
| ..., | |
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16 |
| } | |
| } | |
| [...] | |
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |
| }, | |
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |
| }, | |
| ... | |
| }, | |
| rsType-r16 | NR-RS-Type, |
| ... | |
| } | |
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |
| }, | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |
| }, | |
| ... | |
| }, | |
| rsType | NR-RS-Type, |
| reportInterval | ReportInterval, |
| reportAmount | ENUMERATED {r1, r2, r4, r8, r16, r32, r64, infinity}, |
| reportQuantityCell | MeasReportQuantity, |
| maxReportCells | INTEGER (1..maxCellReport), |
| reportQuantityRS-Indexes | MeasReportQuantity |
| OPTIONAL, -- Need R | |
| maxNrofRS-IndexesToReport | INTEGER (1..maxNrofIndexesToReport) |
| OPTIONAL, -- Need R | |
| includeBeamMeasurements | BOOLEAN, |
| reportAddNeighMeas | ENUMERATED {setup} |
| OPTIONAL, -- Need R | |
| ..., | |
| [ [ | |
| measRSSI-ReportConfig-r16 | MeasRSSI-ReportConfig-r16 |
| OPTIONAL, -- Need R | |
| useT312-r16 | BOOLEAN |
| OPTIONAL, -- Need M | |
| includeCommonLocationInfo-r16 | ENUMERATED {true} |
| OPTIONAL, -- Need R | |
| includeBT-Meas-r16 | SetupRelease {BT-NameList-r16} |
| OPTIONAL, -- Need M | |
| includeWLAN-Meas-r16 | SetupRelease {WLAN-NameList-r16} |
| OPTIONAL, -- Need M | |
| includeSensor-Meas-r16 | SetupRelease {Sensor-NameList-r16} |
| OPTIONAL -- Need M | |
| ] ] | |
| } | |
| [...] | |
| NR-RS-Type ::= | ENUMERATED {ssb, csi-rs} |
| MeasTriggerQuantity ::= | CHOICE { |
| rsrp | RSRP-Range, |
| rsrq | RSRQ-Range, |
| sinr | SINR-Range |
| } | |
| MeasTriggerQuantityOffset ::= | CHOICE { |
| rsrp | INTEGER (−30..30), |
| rsrq | INTEGER (−30..30), |
| sinr | INTEGER (−30..30) |
| } | |
| MeasReportQuantity ::= | SEQUENCE { |
| rsrp | BOOLEAN, |
| rsrq | BOOLEAN, |
| sinr | BOOLEAN |
| } | |
| [...] | |

CondTriggerConfig field descriptions

a3-Offset
Offset value(s) to be used in NR conditional reconfiguration triggering condition for cond event a3. The actual value is
field value * 0.5 dB.
a5-Threshold1/ a5-Threshold2
Threshold value associated to the selected trigger quantity (e.g. RSRP, RSRQ, SINR) per RS Type (e.g. SS/PBCH
block, CSI-RS) to be used in NR conditional reconfiguration triggering condition for cond event a5. In the same
condeventA5, the network configures the same quantity for the MeasTriggerQuantity of the a5-Threshold1 and for the
MeasTriggerQuantity of the a5-Threshold2.
condEventId
Choice of NR conditional reconfiguration event triggered criteria.
timeToTrigger
Time during which specific criteria for the event needs to be met in order to execute the conditional reconfiguration
evaluation.

ReportConfigNR field descriptions

reportType
Type of the configured measurement report. In EN-DC, network does not configure report of type reportCGI using SRB3.
The CondTriggerConfig is used for CHO or CPC configuration.
[...]

EventTriggerConfig field descriptions

a3-Offset/a6-Offset
Offset value(s) to be used in NR measurement report triggering condition for event a3/a6. The actual value is field value
* 0.5 dB.
aN- ThresholdM
Threshold value associated to the selected trigger quantity (e.g. RSRP, RSRQ, SINR) per RS Type (e.g. SS/PBCH
block, CSI-RS) to be used in NR measurement report triggering condition for event number aN. If multiple thresholds are
defined for event number aN, the thresholds are differentiated by M. The network configures aN-Threshold1 only for
events A1, A2, A4, A5 and a5-Threshold2 only for event A5. In the same eventA5, the network configures the same
quantity for the MeasTriggerQuantity of the a5-Threshold1 and for the MeasTriggerQuantity of the a5-Threshold2.
channelOccupancyThreshold
RSSI threshold which is used for channel occupancy evaluation.
eventId
Choice of NR event triggered reporting criteria.
maxNrofRS-IndexesToReport
Max number of RS indexes to include in the measurement report for A1-A6 events.
maxReportCells
Max number of non-serving cells to include in the measurement report.
reportAddNeighMeas
Indicates that the UE shall include the best neighbour cells per serving frequency.
reportAmount
Number of measurement reports applicable for eventTriggered as well as for periodical report types.
reportOnLeave
Indicates whether or not the UE shall initiate the measurement reporting procedure when the leaving condition is met for
a cell in cellsTriggeredList, as specified in 5.5.4.1.
reportQuantityCell
The cell measurement quantities to be included in the measurement report.
reportQuantityRS-Indexes
Indicates which measurement information per RS index the UE shall include in the measurement report.
timeToTrigger
Time during which specific criteria for the event needs to be met in order to trigger a measurement report.
useT312
If value TRUE is configured, the UE shall use the timer T312 with the value t312 as specified in the corresponding
measObjectNR. If value FALSE is configured, the timer T312 is considered as disabled. Network configures value TRUE
only if reportType is set to eventTriggered.
useWhiteCellList
Indicates whether only the cells included in the white-list of the associated measObject are applicable as specified in
5.5.4.1.
[...]

### ************************************** Quotation End **************************************

In a Radio Resource Control (RRC)_CONNECTED state, a User Equipment (UE) measures multiple beams (or at least one) of a cell to derive the cell quality with respect to synchronized signal block (SSB) and/or channel state information reference signal (CSI-RS). And when a triggering event (e.g., criteria/condition for a triggering event) based on the measurement results is met, the UE initiates a measurement reporting procedure to send the measurement results to the Network (NW). A triggering event may have an entering condition and a leaving or exiting condition. The UE may initiate a measurement reporting procedure if the entering condition and/or leaving condition for a triggering event is met. The triggering events may be that the radio condition of a serving cell and/or neighbor cell becomes better/worse than a threshold. The threshold may be an absolute threshold and/or an amount of offset. The details regarding measurement reports can be found in TS 38.331 [2].

On the other hand, the non-terrestrial networks (NTN) to be introduced in New Radio (NR) are to use an airborne/spaceborne vehicle as a platform for providing mobile services (e.g., RP-201256 [1]). The UE may link to, camp on, and/or connect to the NTN network that involves airborne/spaceborne for transmission. NTN comprises various platforms, including low earth orbiting (LEO) satellites, medium earth orbiting (MEO) satellites, highly elliptical orbiting (HEO) satellites, geostationary earth orbiting (GEO) satellites, non-geostationary orbiting (NGSO) satellites, and/or high-altitude platform stations (HAPS). A LEO satellite could have earth-fixed beam (e.g., the beam is temporarily fixed on a location during a time period) or earth-moving beam (e.g., the beam is continuously moving along with the satellite). More details regarding different NTN platforms could be found in TR 38.821 [3]. The NTN could offer a wide-area coverage and provide NW access in the scenario when terrestrial networks (TN) are unfeasible (e.g., desert, polar area, and/or on an airplane). However, there is a small difference/variation in radio condition/signal strength between the cell edge and cell center in NTN compares to in TN due to the longer distance between the UE and the satellite (e.g., TR 38.821[3]). The NTN UE may thus have difficulty distinguishing whether to trigger a measurement report based on the measurement results (e.g., based on radio condition such as reference signal received power (RSRP)) as currently used in TN.

To solve the issue, based on the Work Item (WI) RP-201256 [1] and TR 38.821 [3], location information in addition to measurement results for coverage management may be introduced. In the 3GPP RAN2 #112 e-meeting, it is agreed that the location-based measurement event, in combination with the existing measurement event in NR, should be supported in NTN. Therefore, a location-based triggering event combined with an existing triggering event (based on radio condition) may be defined for NTN. For example, a NTN UE may be configured to trigger a measurement report (or initiate a measurement reporting procedure) based on a combined triggering condition of a first triggering event and a second triggering event. The first triggering event may be based on radio condition (e.g., Event A1, Event A2, Event A3, Event A4, Event A5, Event A6, CondEvent A3 and/or CondEvent A5 in TS 38.331 [2]). The second triggering event may be based on location (e.g., the distance between the UE and a reference location such as cell center). The UE may trigger a measurement report (or initiate a measurement reporting procedure) when both the first triggering event and second triggering event (e.g., the combined triggering condition) are met.

On the other hand, it may be possible that a UE is configured with a triggering event based on location (e.g., the second triggering event, based on distance between the UE and a reference location such as cell center) solely, e.g., without being configured with the first triggering event. In such a case, the UE could trigger a measurement report (or initiate a measurement reporting procedure) when the second triggering event is met (even if the first triggering event is not met).

It is assumed that the configuration of each event (e.g., the first or the second triggering event) has its own associated parameters, respectively (e.g., timeToTrigger, reportOnLeave, useWhiteCellList). However, if the UE is configured to trigger a measurement report (or initiate a measurement reporting procedure) based on a combined triggering condition of more than one triggering event (e.g., the first triggering event and the second triggering event), which value to be used for the parameter(s) corresponding to the combined triggering condition would be an issue. If the measurement reporting procedure is associated with multiple triggering events while all the events need to be fulfilled, some parameters configured for/in each triggering event may be a duplicate and cause confusion.

For example, there may be a first parameter (e.g., timeToTrigger) with a first value configured for/in the first triggering event and the first parameter with a second value configured for/in the second triggering event. The first parameter with the first value may specify the length of duration for the first triggering event needed to be met to trigger a measurement report. The first parameter with the second value may specify the length of duration for the second triggering event needed to be met to trigger a measurement report. The first value and the second value may be time duration in milliseconds (ms). The first value may be different from the second value. When the first triggering event has been met for the time duration with the first value, the second triggering event may not have been met for the time duration with the second value. When the second triggering event has been met for the time duration with the second value, the first triggering event may no longer be met. The UE may not know whether to trigger a measurement report since the two triggering events are not met in the same duration.

For example, there may be a second parameter (e.g., reportOnLeave) with a third value configured for/in the first triggering event and the second parameter with a fourth value configured for/in the second triggering event. The second parameter with the third value may indicate whether to initiate a measurement reporting procedure when the leaving condition in the first triggering event is met. The second parameter with the fourth value may indicate whether to initiate a measurement reporting procedure when the leaving condition in the second triggering event is met. The third value and the fourth value may be a Boolean value.

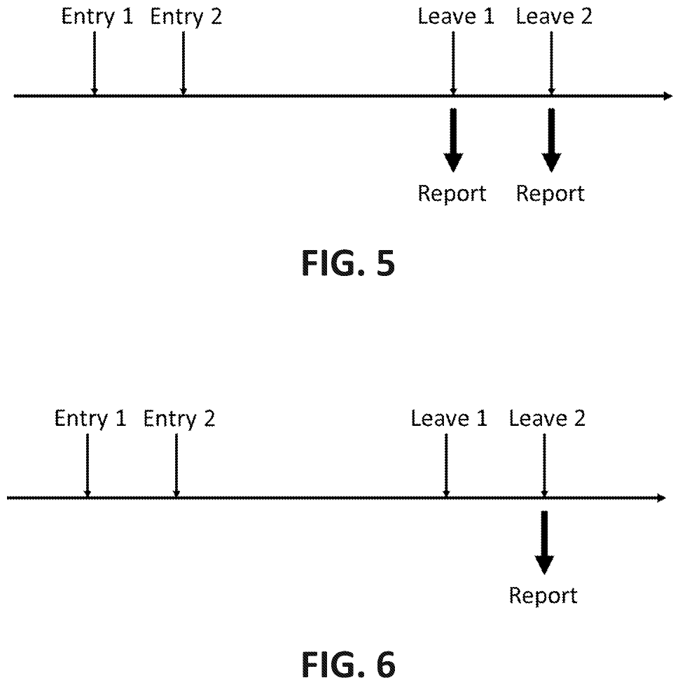

The second parameter (e.g., reportOnLeave) may be treated separately for the first triggering event and second triggering event with the different value. In one example, the UE is configured to trigger a measurement report based on a combined triggering condition of a first triggering event and a second triggering event, and a measurement report may be triggered when (or in response to) the entering conditions for the first triggering event and second triggering event have been met. If the second parameter (e.g., reportOnLeave) for both the first triggering event and the second triggering event are set to TRUE, the UE may trigger a measurement report when the leaving conditions for the first and second triggering event are met. However, as shown in FIG. 5, the UE may trigger a measurement report when the leaving condition for the first triggering event is met at the first timing and trigger another measurement report when the leaving condition for the second triggering event is met at the second timing. The measurement reports triggered at both the first timing and the second timing seem unnecessary since the NW could know the combined triggering condition has not been met by either of the measurement reports.

In another example, the UE is configured to trigger a measurement report based on a combined triggering condition of a first triggering event and a second triggering event, and a measurement report may be triggered when (or in response to) the entering conditions for the first and second triggering event have been met. If the second parameter (e.g., reportOnLeave) for the first triggering event is set to TRUE and the second parameter for the second triggering event is set to FALSE, as shown in FIG. 6, the UE may trigger a measurement report when the leaving condition for the first triggering event is met at the first timing and not trigger a measurement report when the leaving condition for the second triggering event is met at the second timing, regardless of whether the first timing or the second timing is earlier. However, the NW should be informed that the combined triggering condition has not been met as soon as possible. Otherwise, the prepared handover (or conditional handover) may not be suitable for the up-to-date UE condition.

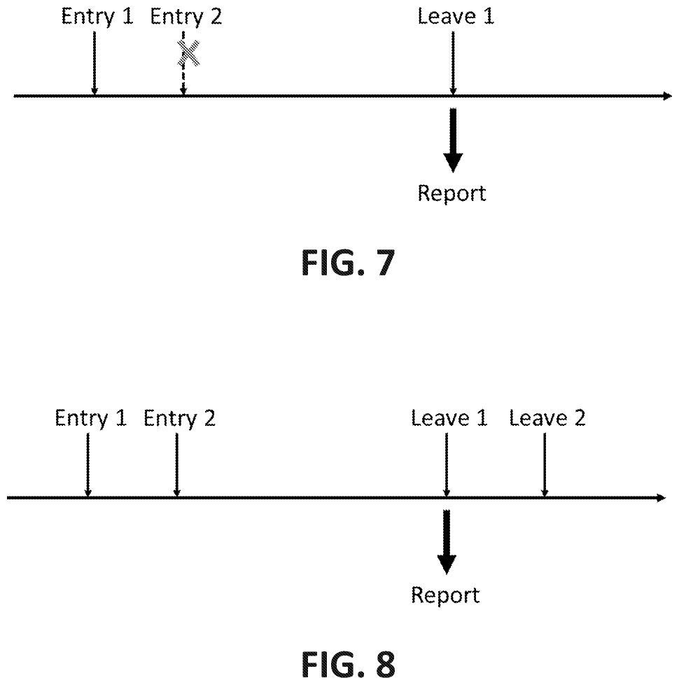

In another example, the UE is configured to trigger a measurement report based on a combined triggering condition of a first triggering event and a second triggering event, and the entering conditions for the first and second triggering event have not been met (e.g., the entering condition for the first triggering event is met but the entering condition for the second triggering event has not been met), so the UE does not trigger a measurement report. However, as shown in FIG. 7, if the second parameter (e.g., reportOnLeave) for one of the events (e.g., the first triggering event) is set to TRUE, the UE may trigger a measurement report when the leaving condition for the first triggering event is met (possibly the entering condition for the first triggering event has been met). In such as case, the triggered measurement report seems unnecessary since it may not be beneficial for the NW to prepare (or update) a candidate target cell.

When the UE is configured with two triggering events in a measurement configuration (e.g., a combined triggering condition), the UE is expected to trigger a measurement report when both the triggering events are met. However, if the third value is TRUE and the fourth value is FLASE, the UE may trigger a measurement report when only the leaving condition in the first triggering event is met. The second triggering event is not met when the UE reports measurement results in this case.

If the UE is configured to trigger a measurement report based on a combined triggering condition of a first triggering event and a second triggering event, and the second parameter (e.g., reportOnLeave) for the combined triggering condition is determined to be TRUE (e.g., based on method described below), the UE could trigger a measurement report if the leaving condition for either the first triggering event or the second triggering event has been met. Once the measurement report has been triggered due to one of the leaving conditions having been met, the UE may not trigger a measurement report if the leaving condition for both the first triggering event and the second triggering event have been met (e.g., as shown in FIG. 8). Alternatively, the UE could trigger a measurement report if the leaving condition for both the first triggering event and the second triggering event have been met (e.g., as shown in FIG. 6). Possibly no measurement report is triggered if the leaving condition for one of the events has been met.

Moreover, for a combined triggering condition, if a measurement report due to fulfilling the entering condition has not been triggered, the UE does not trigger a measurement report due to fulfilling the leaving condition (even if the reportOnLeave is set to TRUE).

For example, there may be a third parameter (e.g., useWhiteCellList) with a fifth value configured for/in the first triggering event and the third parameter with a sixth value configured for/in the second triggering event. The third parameter with the fifth value may indicate whether only the neighbor cells included in the white-list are applicable for the first triggering event. The third parameter with the sixth value may indicate whether only the neighbor cells included in the white-list are applicable for the second triggering event. The fifth value and the sixth value may be a Boolean value. If the fifth value and the sixth value is different, the UE may consider the first triggering event and second triggering event for different groups of neighbor cells. However, the two triggering events need to be met on the same cell (e.g., a neighbor cell) to trigger a measurement report. Once one of the values of the third parameter is TRUE, the UE may report the measurement results only for the neighbor cells included in the white-list. If the fifth value is TRUE and the sixth value is FALSE, it is inefficient for the UE to examine the second triggering event on the neighbor cells not included in the white-list.

Therefore, when the measurement reporting procedure is associated with multiple triggering events, the UE needs to know how to determine (value of) the first, second, and/or third parameters.

To solve the issue, the NW could configure the same value for a parameter in/for the triggering events in a measurement configuration. For example, if the NW configures a UE to trigger a measurement report (or initiate a measurement reporting procedure) based on a combined triggering condition (e.g., a first triggering event and a second triggering event), at least a parameter of all the triggering events associated with the combined triggering condition (e.g., a parameter of the first triggering event and the parameter of the second triggering event) need to be configured with the same value. For example, if the NW configures a UE to trigger a measurement report (or initiate a measurement reporting procedure) based on a combined triggering condition (e.g., a first triggering event and a second triggering event), at least a parameter of all the triggering events associated with the combined triggering condition (e.g., a parameter of the first triggering event and the parameter of the second triggering event) are not allowed to be configured with different values. The parameter may be timeToTrigger. The parameter may be reportOnLeave. The parameter may be use WhiteCellList.

The UE may initiate a measurement reporting procedure when (or in response to) all the triggering events associated with the combined triggering condition (e.g., the first triggering event and the second triggering event) are met. The NW could configure the same length of duration to the first parameters (e.g., timeToTrigger) in/for the triggering events (e.g., the first triggering event and the second triggering event). The NW could configure the same Boolean value to the second parameters (e.g., reportOnLeave) in/for the triggering events (e.g., the first triggering event and the second triggering event). The NW could configure the same Boolean value to the third parameters (e.g., use WhiteCellList) in/for the triggering events (e.g., the first triggering event and the second triggering event). The triggering event (e.g., the first triggering event and the second triggering event) configured in the measurement configuration may be a triggering event based on cell quality (e.g., the RSRP/Reference Signal Received Quality (RSRQ)/Signal-to-interference-plus-noise ratio (SINR) of a cell) and/or based on UE location (e.g., the distance between the UE and reference location, such as a cell center). The UE may be configured to trigger a measurement report (or initiate a measurement reporting procedure) based on a combined triggering condition of multiple triggering events (e.g., the first triggering event and the second triggering event). The triggering events (e.g., the first triggering event and the second triggering event) that need to have the same value for the parameter (e.g., timeToTrigger, reportOnleave, useWhileCellList) may be associated with the combined triggering condition.

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality and a second triggering event based on UE location as a combined triggering condition. The NW may configure the first parameters (e.g., timeToTrigger) with the same value in/for the first triggering event and the second triggering event. The UE may initiate a measurement reporting procedure when (or in response to) both the first triggering event and second triggering event are met for a time duration with the value in the first parameter. The NW may configure the second parameters (e.g., reportOnLeave) as TRUE in/for the first triggering event and the second triggering event. The UE may initiate a measurement reporting procedure when (or in response to) the leaving conditions in both first and second triggering events are met. The UE may initiate a measurement reporting procedure when (or in response to) the leaving condition in one of the first and second triggering events is met. The NW may configure the second parameters (e.g., reportOnLeave) as FALSE in/for the first triggering event and the second triggering event. The UE may not initiate a measurement reporting procedure when (or in response to) any of the leaving conditions in the first triggering event and the second triggering event are met. The NW may configure the third parameters (e.g., useWhiteCellList) as TRUE in/for the first triggering event and the second triggering event. The UE may examine the first triggering event and the second triggering event on the neighbor cells included in the white-list. The NW may configure the third parameters (e.g., useWhiteCellList) as FALSE in the first triggering event and the second triggering event. The UE may examine the first triggering event and the second triggering event on all the neighbor cells.

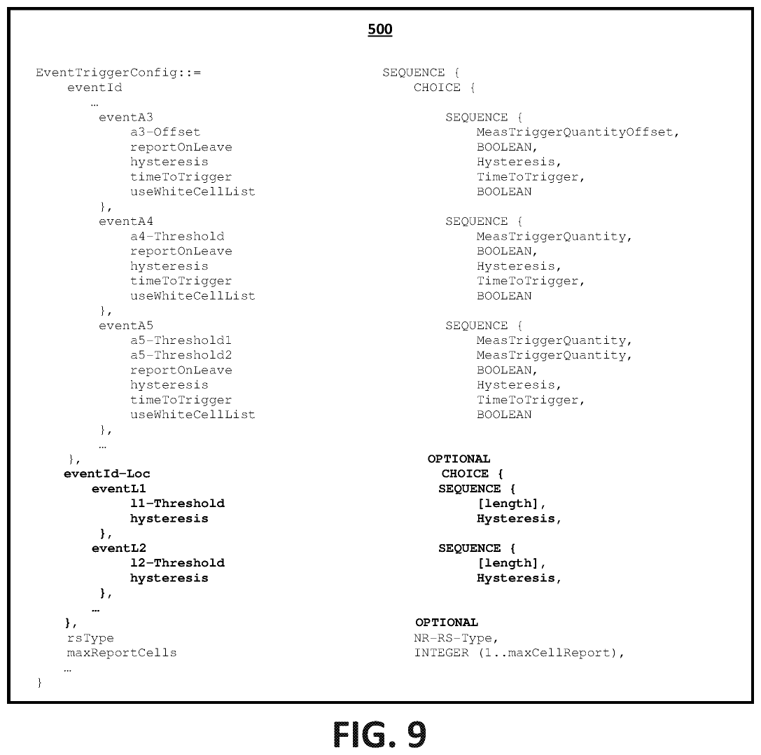

To solve the issue, the NW could configure a parameter in/for one of the triggering events and not configure the parameter in/for the other triggering event(s) in a measurement configuration. For example, the parameter could be associated with one of the triggering events (e.g., triggering event based on cell quality) but not associated with the other triggering event(s) (e.g., triggering event based on UE location). For example, as shown in FIG. 9 as configuration procedure 500, the NW could configure a parameter in/for the triggering event based on cell quality (e.g., eventA3, eventA4 and/or eventA5) and not configure the parameter in/for the triggering event based on UE location (e.g., eventL1 and/or eventL2). Not configuring a parameter may mean that the parameter cannot be configured (e.g., there is no such parameter in the configuration). The UE may initiate a measurement reporting procedure when (or in response to) all the triggering events associated with the combined triggering condition (e.g., the first triggering event and the second triggering event) are met. The parameter may be a first parameter (e.g., timeToTrigger), second parameter (e.g., reportOnLeave), and/or third parameter (e.g., useWhiteCellList). The triggering event configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on a combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality and a second triggering event based on UE location as combined triggering condition. The NW may configure the second parameters (e.g., reportOnLeave) as TRUE in/for the first triggering event and not configure another second parameter (e.g., reportOnLeave) in/for the second triggering event. The UE may initiate a measurement reporting procedure when (or in response to) the leaving conditions in both first and second triggering events are met. The UE may initiate a measurement reporting procedure when (or in response to) the leaving condition in one of the first and second triggering events is met. The UE may consider the second parameters (e.g., reportOnLeave) as TRUE in/for the second triggering event and/or the combined triggering condition. The UE may not initiate a measurement reporting procedure when (or in response to) any of the leaving condition in the first triggering event and the second triggering event is met. The UE may consider the second parameters (e.g., reportOnLeave) as FALSE in/for the second triggering event and/or the combined triggering condition. The NW may configure the second parameters (e.g., reportOnLeave) as FALSE in/for the first triggering event and the second triggering event. The UE may not initiate a measurement reporting procedure when (or in response to) any of the leaving condition in the first triggering event and the second triggering event is met.

In one example, the NW could configure a parameter in/for one of the triggering events. The NW could not configure the parameter in/for more than one triggering event.

For example, again as shown in FIG. 9, the NW may configure a first triggering event based on cell quality (e.g., eventA4) and a second triggering event based on UE location (e.g., eventL1) as a combined triggering condition. The NW may configure the first parameter (e.g., timeToTrigger), second parameter (e.g., reportOnLeave) and/or third parameter (e.g., useWhiteCellList) in/for the first triggering event (e.g., eventA4). The NW may not configure above parameters in/for the second triggering event (e.g., eventL1). The NW may configure the first triggering event in a first event Identity (ID) (e.g., eventId) and the second triggering event in a second event ID (e.g., eventId-Loc). The NW may configure the first event ID and second event ID in an event triggering configuration (e.g., EventTriggerConfig) in the measurement configuration. The second event ID may be optional. The second event ID may be present when (or in response to) the combined triggering condition is configured. The second event ID may be absent when (or in response to) the combined triggering condition is not configured. The UE may initiate a measurement reporting procedure when (or in response to) both the first triggering event and second triggering event (e.g., the combined triggering condition) are met.

In another example, the NW could configure a parameter as optional in/for the triggering events. The NW could configure the parameter as not optional in/for one of the triggering events and configure the parameter as optional in/for the other triggering event(s). The NW could configure the parameter as optional in/for all the triggering events. The NW could not configure the parameter as not optional in/for all the triggering events. A parameter in/for one of the triggering events may be present, while the parameter in/for the other triggering event(s) may be absent in the measurement configuration.

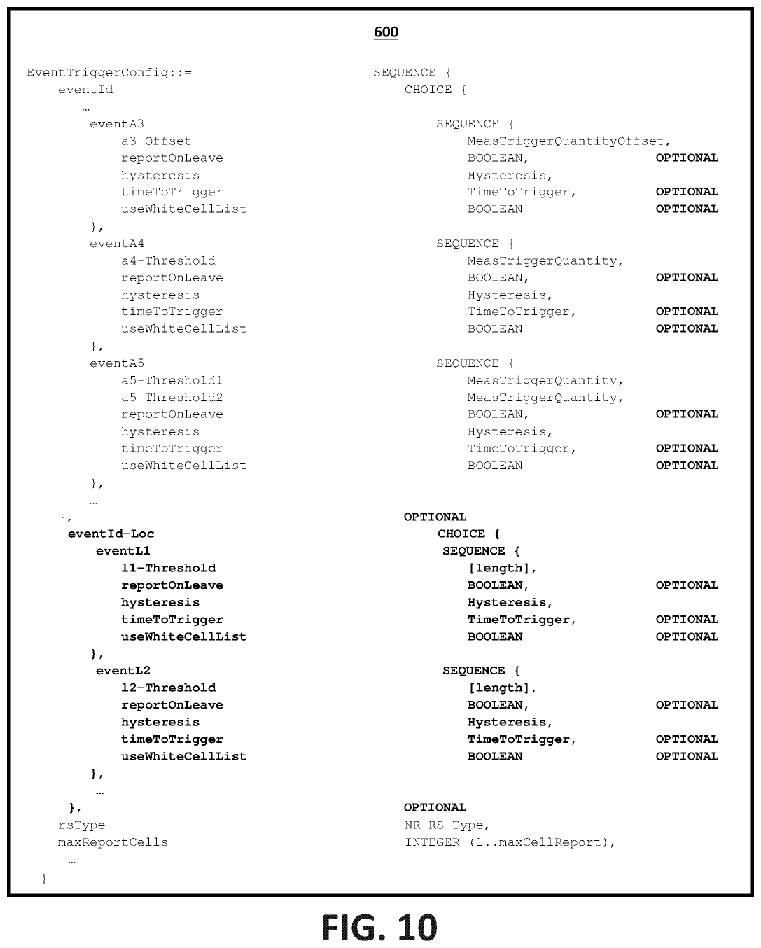

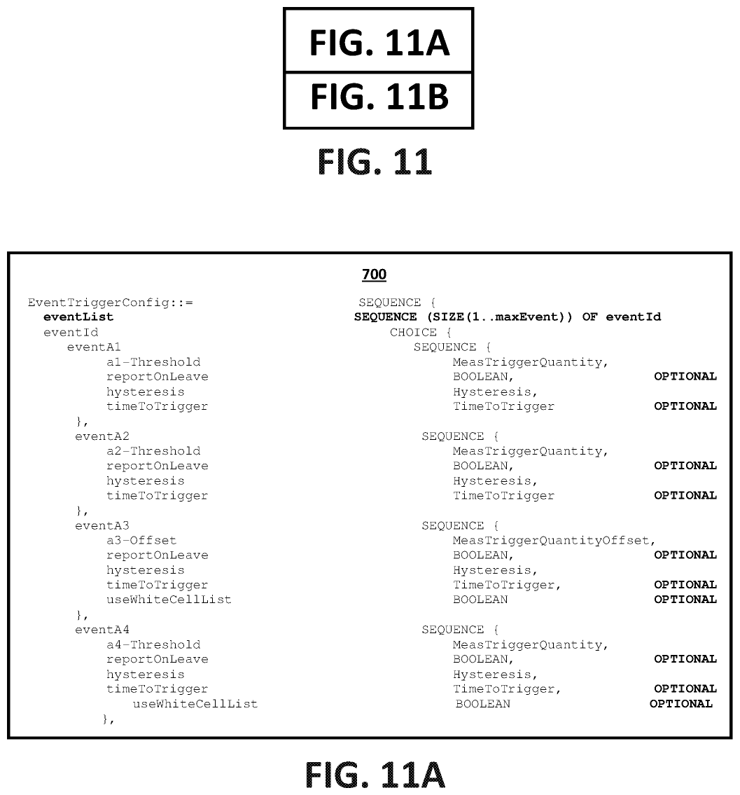

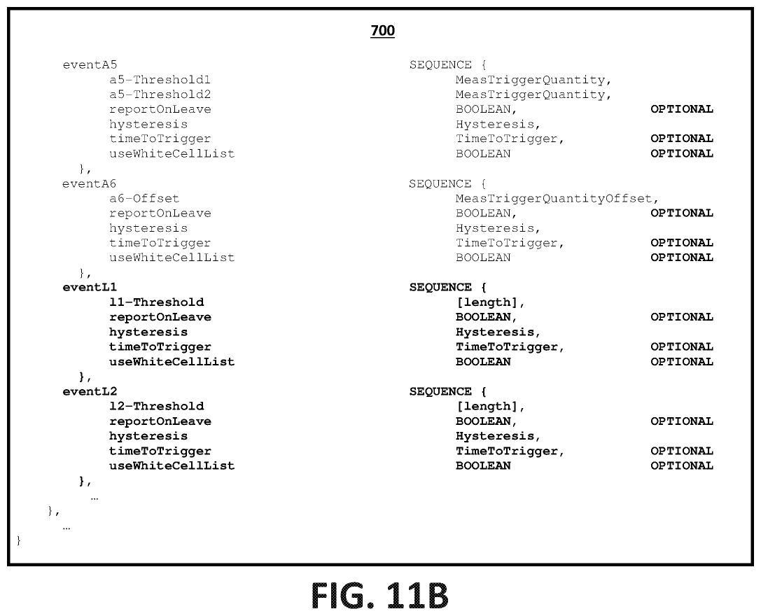

For example, as shown in FIGS. 10 and 11 as configuration procedures 600 and 700, respectively, the NW may configure a first triggering event based on cell quality (e.g., eventA4) and a second triggering event based on UE location (e.g., eventL1) as a combined triggering condition. The NW may configure the first parameters (e.g., timeToTrigger), second parameters (e.g., reportOnLeave), and/or third parameters (e.g., useWhiteCellList) in/for the first triggering event (e.g., eventA4) and the second triggering event (e.g., eventL1). If the first, second and/or third parameters are present and/or configured in the first triggering event (e.g., eventA4), above parameters in the second triggering event (e.g., eventL1) may be absent. If the first, second and/or third parameters are not present and/or configured in the first triggering event (e.g., eventA4), the above parameters in the second triggering event may be present (e.g., eventL1). If the first, second and/or third parameters are present (and/or configured) in the second triggering event (e.g., eventL1), the first, second and/or third parameters in the first triggering event (e.g., eventA4) may be absent. If the first, second and/or third parameters are not present (and/or configured) in the second triggering event (e.g., eventL1), the first, second and/or third parameters in the first triggering event may be present (e.g., eventA4). The UE may initiate a measurement reporting procedure when (or in response to) both the first triggering event and second triggering event are met.

As shown in FIG. 10 as configuration procedure 600, the NW may configure the first triggering event in a first event ID (e.g., eventId) and the second triggering event in a second event ID (e.g., eventId-Loc). The NW may configure the first event ID and second event ID in an event triggering configuration (e.g., EventTriggerConfig) in the measurement configuration. The first event ID and the second event ID may be optional. Both the first event ID and second event ID may be present when (or in response to) the combined triggering condition is configured. One of the first event ID and second event ID may be absent when (or in response to) the combined triggering condition is not configured.

As shown in FIG. 11 (11A-11B) as configuration procedure 700, the NW may configure the first triggering event and the second triggering event in the first event ID (e.g., eventId). The NW may configure a list of the first event IDs in an event triggering configuration (e.g., EventTriggerConfig) in the measurement configuration.

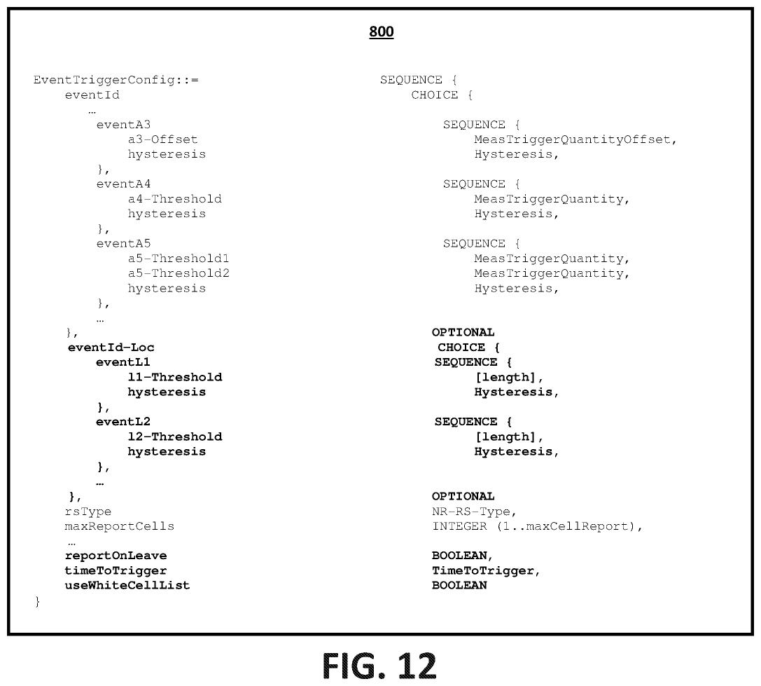

To solve the issue, the NW could configure a parameter in a measurement configuration for all the triggering events in a measurement configuration. For example, as shown in FIG. 12 as configuration procedure 800, the NW could configure a parameter (e.g., for a combined triggering condition) in an event triggering configuration (e.g., EventTriggerConfig) in the measurement configuration. The NW could configure triggering events (e.g., eventA3, eventA4, eventA5, eventL1, eventL2) in the event triggering configuration. The NW could not individually configure a parameter in/for each triggering events (e.g., eventA3, eventA4, eventA5, eventL1, eventL2). The parameter may be commonly applied to all triggering events (e.g., of a combined triggering condition). The parameter may not be specific to a specific triggering event (e.g., of a combined triggering condition). The UE may initiate a measurement reporting procedure when (or in response to) all the triggering events associated with the combined triggering condition (e.g., the first triggering event and the second triggering event) are met. The parameter may be a first parameter (e.g., timeToTrigger), second parameter (e.g., reportOnLeave) and/or third parameter (e.g., use WhiteCellList). The triggering event configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on a combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality (e.g., eventA4) and a second triggering event based on UE location (e.g., eventL1) as a combined triggering condition in a list of event IDs in an event triggering configuration (e.g., EventTriggerConfig) in the measurement configuration. The NW may configure the first parameter (e.g., timeToTrigger), second parameter (e.g., reportOnLeave) and/or third parameter (e.g., useWhiteCellList) in the event triggering configuration (e.g., EventTriggerConfig). The NW may not configure the above parameters separately in/for the first triggering event and/or second triggering event in an event ID (e.g., eventId) (e.g., for a combined triggering condition). The UE may initiate a measurement reporting procedure when (or in response to) both the first triggering event and second triggering event are met.

For example, the NW may configure a first triggering event based on cell quality and a second triggering event based on UE location as a combined triggering condition in an event triggering configuration (e.g., EventTriggerConfig). The NW may configure the second parameters (e.g., reportOnLeave) as TRUE in the event triggering configuration (e.g., EventTriggerConfig). The UE may initiate a measurement reporting procedure when (or in response to) the leaving conditions in both first and second triggering events are met. The UE may initiate a measurement reporting procedure when (or in response to) the leaving condition in one of the first and second triggering events is met. The NW may configure the second parameters (e.g., reportOnLeave) as FALSE in the event triggering configuration (e.g., Event TriggerConfig). The UE may not initiate a measurement reporting procedure when (or in response to) any of the leaving conditions in the first triggering event and the second triggering event is met.

To solve the issue, the UE could select the shortest value of a parameter in/for the triggering events. The parameter may be a first parameter (e.g., timeToTrigger). The triggering events are configured as a combined triggering condition in a measurement configuration. The UE may initiate a measurement reporting procedure when (or in response to) all the triggering events associated with the combined triggering condition (e.g., the first triggering event and the second triggering event) are met. The triggering events configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on the combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality and a second triggering event based on UE location as a combined triggering condition. The NW may configure the first parameters (e.g., timeToTrigger) in the first triggering event and the second triggering event. The value of the first parameter in the first triggering event may be shorter than the value in the second triggering event. Then the UE may initiate a measurement reporting procedure when (or in response to) both the first and second triggering events are met for the time duration with the value of the first parameter in the first triggering event.

To solve the issue, the UE could select the longest value of a parameter in/for the triggering events. The parameter may be a first parameter (e.g., timeToTrigger). The triggering events are configured as a combined triggering condition in a measurement configuration. The UE may initiate a measurement reporting procedure when (or in response to) all the triggering events associated with the combined triggering condition (e.g., the first triggering event and the second triggering event) are met. The triggering event configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on the combined triggering condition of multiple triggering events (e.g., the first triggering event and the second triggering event).

For example, the NW may configure a first triggering event based on cell quality and a second triggering event based on UE location as a combined triggering condition. The NW may configure the first parameters (e.g., timeToTrigger) in the first triggering event and the second triggering event. The value of the first parameter in the second triggering event may be longer than the value in the first triggering event. The UE may initiate a measurement reporting procedure when (or in response to) both the first and second triggering events are met for the time duration with the value of the first parameter in the second triggering event.

To solve the issue, the UE could consider the value of a parameter as TRUE if one of the values of the parameters in/for the triggering events is TRUE. The UE could consider the value of a parameter as FALSE if all of the values of the parameter in/for the triggering events are FALSE. It could be applied to the case that only one triggering event among the combined triggering events is configured with the parameter (e.g., the other triggering event is not configured with the parameter). The triggering events are configured as a combined triggering condition in a measurement configuration. The UE may initiate a measurement reporting procedure when (or in response to) all the triggering events associated with the combined triggering condition (e.g., the first triggering event and the second triggering event) are met. The parameter may be a second parameter (e.g., reportOnLeave) and/or a third parameter (e.g., useWhiteCellList). The triggering event configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on the combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., condition) associated with the first triggering event is not met.

For example, the NW may configure a first triggering event based on cell quality and a second triggering event based on UE location as a combined triggering condition. The NW may configure the second parameters (e.g., reportOnLeave) in/for the first triggering event and the second triggering event. If one of the values of the second parameters in/for the two triggering events is TRUE, the UE may trigger a measurement report when (or in response to) both the leaving conditions in the first and second triggering events are met. If one of the values of the second parameters in/for the two triggering events is TRUE, the UE may trigger a measurement report when (or in response to) one of the leaving conditions in the first and second triggering events is met. If both of the values of the second parameters in/for the two triggering events are FALSE, the UE may not trigger a measurement report when (or in response to) the leaving condition(s) in the first triggering event and/or second triggering event are met.

For example, the NW may configure a first triggering event based on cell quality and a second triggering event based on UE location as a combined triggering condition. The NW may configure the third parameters (e.g., useWhiteCellList) in/for the first triggering event and the second triggering event. If both the values of the third parameters in/for the two triggering events are FALSE, the UE may examine the first and second triggering events on all the neighbor cells. If one of the values of the third parameters in/for the two triggering events is TRUE, the UE may examine the first and second triggering events on the neighbor cells included in the white-list.

To solve the issue, the UE could consider the value of a parameter as FALSE if one of the values of the parameters in/for the triggering events is FALSE. The UE could consider the value of a parameter as TRUE if all of the values of the parameters in/for the triggering events are TRUE. It could be applied to the case that only one triggering event among the combined triggering events is configured with the parameter (e.g., the other triggering event is not configured with the parameter). The triggering events are configured as a combined triggering condition in a measurement configuration. The UE may initiate a measurement reporting procedure when (or in response to) all the triggering events associated with the combined triggering condition (e.g., the first triggering event and the second triggering event) are met. The parameter may be a second parameter (e.g., reportOnLeave) and/or a third parameter (e.g., useWhiteCellList). The triggering event configured in the measurement configuration may be a triggering event based on cell quality (e.g., the RSRP/RSRQ/SINR of a cell) and/or based on UE location (e.g., the distance between the UE and reference location such as a cell center). The UE may be configured to trigger a measurement report (or initiate a measurement reporting procedure) based on the combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality and a second triggering event based on UE location as a combined triggering condition. The NW may configure the second parameters (e.g., reportOnLeave) in/for the first triggering event and the second triggering event. If one of the values of the second parameters in/for the two triggering events is FALSE, the UE may not trigger a measurement report when (or in response to) the leaving condition(s) in the first triggering event and/or second triggering event are met. If both of the values of the second parameters in/for the two triggering events are TRUE, the UE may trigger a measurement report when (or in response to) both the leaving conditions in the first and second triggering events are met. If both of the values of the second parameters in/for the two triggering events are TRUE, the UE may trigger a measurement report when (or in response to) one of the leaving conditions in the first and second triggering events is met.

For example, the NW may configure a first triggering event based on cell quality and a second triggering event based on UE location as a combined triggering condition. The NW may configure the third parameters (e.g., useWhiteCellList) in/for the first triggering event and the second triggering event. If both the values of the third parameters in/for the two triggering events are TRUE, the UE may examine the first and second triggering events on the neighbor cells included in the white-list. If one of the values of the third parameters in/for the two triggering events is FALSE, the UE may examine the first and second triggering event on all the neighbor cells.

To solve the issue, the UE could use the (value of a) parameter in/for a specific triggering event among the triggering events. The triggering events are configured as a combined triggering condition in a measurement configuration. The UE may initiate a measurement reporting procedure when (or in response to) all the triggering events associated with the combined triggering condition (e.g., the first triggering event and the second triggering event) are met. The parameter may be configured in/for the triggering events. The parameter may be a first parameter (e.g., timeToTrigger), second parameter (e.g., reportOnLeave) and/or third parameter (e.g., use WhiteCellList). The UE may use the (value of the) parameter in/for one of the triggering events. The UE may ignore the (value of the) parameter in/for the other triggering event(s). The triggering event configured in the measurement configuration may be a triggering event based on cell quality (e.g., the RSRP/RSRQ/SINR of a cell) and/or based on UE location (e.g., the distance between the UE and reference location such as a cell center). The UE may use the (value of the) parameter in/for the triggering event which is based on cell quality. The UE may use the (value of the) parameter in/for the triggering event which is based on UE location. The UE may use the (value of the) parameter in/for the measurement-based triggering event. The UE may use the (value of the) parameter in/for the location-based triggering event. The UE may use the (value of the) parameter in/for the triggering event which is associated to serving cell. The UE may use the (value of the) parameter in/for the triggering event which is associated to neighbor cell. The UE may use the (value of the) parameter in/for the triggering event which is indicated by the NW. The NW may configure an indication in the measurement configuration for UE to select the (value of the) parameter in/for which triggering event. The UE may be configured to trigger a measurement report (or initiate a measurement reporting procedure) based on a combined triggering condition of multiple triggering events (e.g., the first triggering event and the second triggering event).

The UE may not be configured to trigger (or initiate) a measurement report based on the first triggering event solely. The UE may not be configured to trigger (or initiate) a measurement report based on the second triggering event solely. The UE may not trigger (or initiate) a measurement report if (or in response to) the triggering condition (e.g., entering condition) associated with the first triggering event is met but the triggering condition (e.g., entering condition) associated with the second triggering event is not met. The UE may not trigger (or initiate) a measurement report if (or in response to) the triggering condition (e.g., entering condition) associated with the second triggering event is met but the triggering condition (e.g., entering condition) associated with the first triggering event is not met.

For example, the NW may configure a first triggering event based on cell quality and a second triggering event based on UE location as a combined triggering condition. The NW may configure the second parameters (e.g., reportOnLeave) in the first triggering event and the second triggering event. If the value of the second parameter in/for the first triggering event is FALSE, the UE may not trigger a measurement report when (or in response to) the leaving condition(s) in the first triggering event and/or second triggering event are met. If the value of the second parameter in/for the first triggering event is TRUE, the UE may trigger a measurement report when (or in response to) both the leaving conditions in the first triggering event and second triggering event are met. If the value of the second parameter in/for the first triggering event is TRUE, the UE may trigger a measurement report when (or in response to) one of the leaving conditions in the first triggering event and second triggering event is met.

The UE may receive configurations related to measurement and/or a measurement report (or measurement reporting). The (measurement) configuration may include the combined triggering condition for a measurement report. The combined triggering condition may be the multiple triggering events (e.g., the first triggering event and the second triggering event) which need to be met to trigger a measurement report (or initiate a measurement reporting procedure). The (measurement) configuration may include two or more than two triggering events for a measurement report. The triggering event may comprise entering a condition and/or leaving a condition. The entering condition and/or leaving condition may be and/or comprise one or more formula. The UE may trigger a measurement report in response to the entering conditions of the first triggering event and the second triggering event being fulfilled.

The (measurement) configuration may not include a non-combined triggering condition for a measurement report. The (measurement) configuration may not include a single triggering condition for a measurement report. The (measurement) configuration may not include a first triggering event without a second triggering event for a measurement report. The (measurement) configuration may not include a second triggering event without a first triggering event for a measurement report. The UE may not trigger a measurement report in response to the entering condition of the first triggering event being fulfilled (e.g., and the entering condition of the second triggering event is not fulfilled). The UE may not trigger a measurement report in response to the entering condition of the second triggering event being fulfilled (e.g., and the entering condition of the first triggering event is not fulfilled).

The (measurement) configuration may include the first parameter (e.g., timeToTrigger), second parameter (e.g., reportOnLeave) and/or third parameter (e.g., useWhiteCellList) in/for the triggering events. The third parameter may be configured when (or at least one of) the triggering event is associated to neighbor cell(s).

In various embodiments, the triggering events may be associated to serving cell and/or neighbor cell(s). The serving cell could be a special cell (SpCell) of the UE. The serving cell could be a secondary cell (SCell) of the UE. The neighbor cell could be one of a plurality of neighbor cells of the UE.

In various embodiments, the triggering events based on cell quality, the measurement-based triggering events and/or the existing triggering events may be at least one of the below (or the combination of the events below):
The radio condition of the serving cell becomes better than an absolute threshold;
The radio condition of the serving cell becomes worse than an absolute threshold;
The radio condition of a neighbor/candidate cell becomes amount of offset better than the primary cell (PCell)/primary and secondary cell (PSCell);
The radio condition of a neighbor/candidate cell becomes better than an absolute threshold;
The radio condition of the PCell/PSCell and/or serving cell becomes worse than an absolute threshold, and the radio condition of a neighbor/candidate cell and/or SCell becomes better than another absolute threshold;
The radio condition of a neighbor/candidate cell becomes an amount of offset better than the SCell.

In various embodiments, the triggering events based on UE location and/or the location-based triggering events may be at least one of the below (or the combination of the events below):
The distance between the UE and the serving cell center becomes larger than an absolute threshold;
The distance between the UE and the serving cell center becomes smaller than an absolute threshold;
The distance between the UE and a neighbor/candidate cell center becomes larger than an absolute threshold;
The distance between the UE and a neighbor/candidate cell center becomes smaller than an absolute threshold;
The distance between the UE and the serving cell center becomes larger than an absolute threshold, and the distance between the UE and a neighbor/candidate cell center becomes smaller than an absolute threshold;
The distance between the UE and a neighbor/candidate cell center becomes an amount of offset smaller than the distance between the UE and the serving cell center.
The distance between the UE and the serving cell center becomes amount of offset larger than the distance between the UE and a neighbor/candidate cell center.

In various embodiments, the cell (e.g., serving cell, neighbor cell) center may be replaced by other reference locations of a cell. The reference location of a cell could be the geographical location of the cell center on the ground. The reference location of a cell could be a virtual location defined by the network (e.g., the geographical area is split into rectangular grids and the reference location is represented by indices of the grid). The reference location of a cell could be provided by the network to the UE. The reference location of a cell could be derived by the UE (based on e.g., satellite location and mapping of the satellite location to the cell location).

In various embodiments, one, some, and/or all instances of “radio condition” may correspond to, may be supplemented with and/or may be replaced by “cell quality”. The radio condition and/or the measurement results may be represented by RSRP, RSRQ and/or SINR. The radio condition and/or the measurement results may be with respect to a pathloss reference, an average of a set of pathloss references, and/or a reference signal of a beam (e.g., SSB, CSI-RS).

In various embodiments, one, some, and/or all instances of “the triggering event is met” may correspond to, may be supplemented with and/or may be replaced by “the triggering event is fulfilled/satisfied”, “the criteria for the triggering event is met/fulfilled/satisfied”, and/or “the (triggering) condition of/for the triggering event is met/fulfilled/satisfied”.

A similar issue described above could also occur when the measurement configuration and/or the triggering event is used to trigger or initiate a conditional handover (or conditional reconfiguration). The method(s) described above could also be applied to conditional handover (or conditional reconfiguration).

In various embodiments, the measurement report could be replaced by conditional handover (or conditional reconfiguration). For example, the triggering condition to trigger a measurement report could be replaced by the triggering condition to trigger a conditional handover (or conditional reconfiguration).

The UE may be in a cell of a NTN. The UE may be connected to a cell of a NTN. The UE may be connected to a LEO, GEO, MEO, HEO, and/or HAPS.

The UE may be referred to the UE or a RRC entity of the UE.

The UE may be a NR device. The UE may be a NR-light device. The UE may be a reduced capability device. The UE may be a mobile phone. The UE may be a wearable device. The UE may be a sensor. The UE may be a stationary device.

The network may be a network node. The network may be a base station. The network may be an access point. The network may be an eNB. The network may be a gNB. The network may be a gateway.

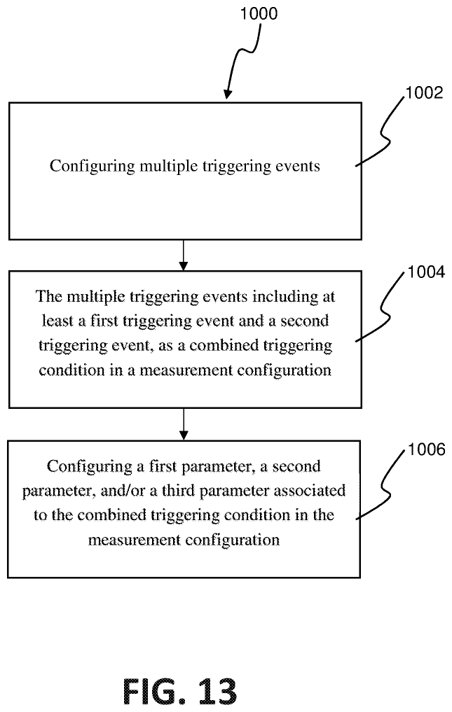

Referring to FIG. 13, with this and other concepts, systems, and methods of the present invention, a method 1000 of a NW comprises configuring multiple triggering events (step 1002), including at least a first triggering event and a second triggering event, as a combined triggering condition in a measurement configuration (step 1004), and configuring a first parameter, a second parameter, and/or a third parameter associated to the combined triggering condition in the measurement configuration (step 1006).

In various embodiments, the first triggering event may be a triggering event based on cell quality.

In various embodiments, the second triggering event may be a triggering event based on UE location.

In various embodiments, the first triggering event and second triggering event may associate to serving cells and/or neighbor cells.

In various embodiments, the first parameter specifies the length of duration for a triggering event (e.g., the first triggering event, the second triggering event) that needs to be fulfilled to trigger a measurement report.

In various embodiments, the second parameter indicates whether to trigger a measurement report when (or in response to) a leaving condition in a triggering event (e.g., the first triggering event, the second triggering event) is fulfilled.

In various embodiments, the third parameter indicates whether only the neighbor cells included in the white-list are applicable for a triggering event (e.g., the first triggering event, the second triggering event).

In various embodiments, the NW configures the same value for a parameter (e.g., the first parameter, second parameter, third parameter) in/for the multiple triggering events (e.g., first triggering event and the second triggering event).

In various embodiments, the NW configures a parameter (e.g., the first parameter, second parameter, third parameter) in/for one of the multiple triggering events (e.g., the first triggering event and the second triggering event).

In various embodiments, the NW does not configure the parameter (e.g., the first parameter, second parameter, third parameter) in/for more than one triggering event among the multiple triggering events (e.g., the first triggering event and the second triggering event).

In various embodiments, the NW configures the parameter present (e.g., the first parameter, second parameter, third parameter) in/for one of the multiple triggering events (e.g., the first triggering event and the second triggering event).

In various embodiments, the NW configures a parameter (e.g., the first parameter, second parameter, third parameter) for all the multiple triggering events (e.g., the first triggering event and the second triggering event).

In various embodiments, the NW does not individually configure the parameter in/for each triggering event among the multiple triggering events (e.g., the first triggering event and the second triggering event).

Referring back to FIGS. 3 and 4, in one or more embodiments from the perspective of a NW, the device 300 includes a program code 312 stored in memory 310 of the transmitter. The CPU 308 could execute program code 312 to: (i) configure multiple triggering events, (ii) wherein the multiple triggering events include at least a first triggering event and a second triggering event, as a combined triggering condition in a measurement configuration, and (iii) configure a first parameter, a second parameter, and/or a third parameter associated to the combined triggering condition in the measurement configuration. Moreover, the CPU 308 can execute the program code 312 to perform all of the described actions, steps, and methods described above, below, or otherwise herein.

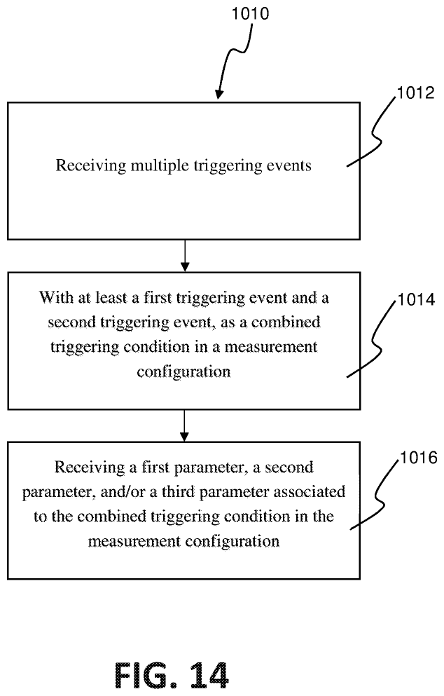

Referring to FIG. 14, with this and other concepts, systems, and methods of the present invention, a method 1010 of a UE comprises receiving multiple triggering events (step 1012), with at least a first triggering event and a second triggering event, as a combined triggering condition in a measurement configuration (step 1014), and receiving a first parameter, a second parameter, and/or a third parameter associated to the combined triggering condition in the measurement configuration (1016).

In various embodiments, the first triggering event may be a triggering event based on cell quality.

In various embodiments, the second triggering event may be a triggering event based on UE location.

In various embodiments, the first triggering event and second triggering event may associate to serving cells and/or neighbor cells.

In various embodiments, the first parameter specifies the length of duration for a triggering event (e.g., the first triggering event, the second triggering event) that needs to be fulfilled to trigger a measurement report.

In various embodiments, the second parameter indicates whether to trigger a measurement report when (or in response to) a leaving condition in a triggering event (e.g., the first triggering event, the second triggering event) is fulfilled.

In various embodiments, the third parameter indicates whether only the neighbor cells included in the white-list are applicable for a triggering event (e.g., the first triggering event, the second triggering event).

In various embodiments, the UE selects the shortest value of the first parameter from the values of the first parameter configured in/for the multiple triggering events (e.g., first triggering event and the second triggering event).

In various embodiments, the UE considers the value of the second parameter as TRUE/FALSE if one of the values of the second parameter in/for the multiple triggering events (e.g., first triggering event and the second triggering event) is TRUE.

In various embodiments, the UE considers the value of the third parameter as TRUE/FALSE if one of the values of the third parameter in/for the multiple triggering events (e.g., first triggering event and the second triggering event) is TRUE.

In various embodiments, the UE uses the value of a parameter (e.g., the first parameter, second parameter, third parameter) in/for a specific triggering event among the multiple triggering events.

Referring back to FIGS. 3 and 4, in one or more embodiments from the perspective of a UE or device, the UE/device 300 includes program code 312 stored in memory 310. The CPU 308 could execute program code 312 to (i) receive multiple triggering events; (ii) wherein at least a first triggering event and a second triggering event, as a combined triggering condition in a measurement configuration; and (iii) receive a first parameter, a second parameter, and/or a third parameter associated to the combined triggering condition in the measurement configuration. Moreover, the CPU 308 can execute the program code 312 to perform all of the described actions, steps, and methods described above, below, or otherwise herein.

In various embodiments, the specific triggering event is one of the multiple triggering events based on cell quality.

In various embodiments, the specific triggering event is one of the multiple triggering events based on UE location.

In various embodiments, the specific triggering event is one of the multiple triggering events associated to serving cells.

In various embodiments, the specific triggering event is one of the multiple triggering events associated to neighbor cells.

In various embodiments, the specific triggering event is one of the multiple triggering events indicated by the NW in the measurement configuration.

In various embodiments, the UE triggers the measurement report and/or initiates a measurement report procedure when (or in response to) the combined triggering condition (e.g., the first triggering event and the second triggering event) in the measurement configuration is fulfilled.

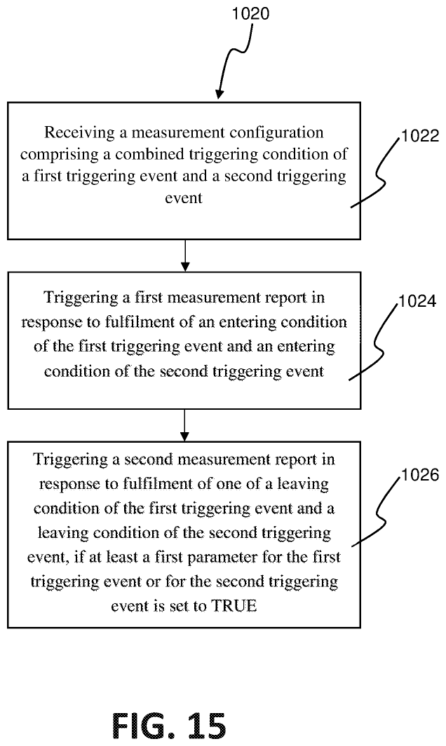

Referring to FIG. 15, with this and other concepts, systems, and methods of the present invention, a method 1020 of a UE comprises receiving a measurement configuration comprising a combined triggering condition of a first triggering event and a second triggering event (step 1022), triggering a first measurement report in response to fulfilment of an entering condition of the first triggering event and an entering condition of the second triggering event (step 1024), and triggering a second measurement report in response to fulfilment of one of a leaving condition of the first triggering event and a leaving condition of the second triggering event if at least a first parameter for the first triggering event or for the second triggering event is set to TRUE (step 1026).

In various embodiments, the first triggering event is a triggering event based on cell quality.

In various embodiments, the second triggering event is a triggering event based on UE location.

In various embodiments, the first parameter is reportOnLeave.

In various embodiments, the UE further receives the first parameter for the first triggering event and does not receive the first parameter for the second triggering event in the measurement configuration.

In various embodiments, the UE further receives the first parameter for the first triggering event and the first parameter for the second triggering event in the measurement configuration.

In various embodiments, the UE further considers the first parameter for the combined triggering condition as TRUE if the first parameter for one of the first triggering event or the second triggering event is set to TRUE.

In various embodiments, the UE further applies the first parameter for the first triggering event as the first parameter for the combined triggering condition.

In various embodiments, the UE does not trigger a third measurement report in response to fulfilment of the entering condition of the first triggering event or the second triggering event.

In various embodiments, the UE is in a NTN.

Referring back to FIGS. 3 and 4, in one or more embodiments from the perspective of a UE or device, the UE/device 300 includes program code 312 stored in memory 310. The CPU 308 could execute program code 312 to (i) receive a measurement configuration comprising a combined triggering condition of a first triggering event and a second triggering event; (ii) trigger a first measurement report in response to fulfilment of an entering condition of the first triggering event and an entering condition of the second triggering event; and (iii) trigger a second measurement report in response to fulfilment of one of a leaving condition of the first triggering event and a leaving condition of the second triggering event, if at least a first parameter for the first triggering event or for the second triggering event is set to TRUE. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving a measurement configuration comprising a combined triggering condition of a first triggering event and a second triggering event;
triggering a first measurement report in response to fulfilment of an entering condition of the first triggering event and an entering condition of the second triggering event; and
triggering a second measurement report in response to fulfilment of one of a leaving condition of the first triggering event, and a leaving condition of the second triggering event, if at least a first parameter for the first triggering event, or for the second triggering event, is set to TRUE.

2. The method of claim 1, wherein the first triggering event is based on cell quality.

3. The method of claim 1, wherein the second triggering event is based on UE location.

4. The method of claim 1, wherein the first parameter is reportOnLeave.

5. The method of claim 1, further comprising receiving the first parameter for the first triggering event, and not receiving the first parameter for the second triggering event, in the measurement configuration.

6. The method of claim 1, further comprising receiving the first parameter for the first triggering event and the first parameter for the second triggering event in the measurement configuration.

7. The method of claim 1, further comprising considering the first parameter for the combined triggering condition as TRUE if the first parameter for one of the first triggering event or the second triggering event is set to TRUE.

8. The method of claim 1, further comprising applying the first parameter for the first triggering event as the first parameter for the combined triggering condition.

9. The method of claim 1, further comprising not triggering a third measurement report in response to fulfilment of the entering condition of the first triggering event or the second triggering event.

10. The method of claim 1, wherein the UE is in a Non-Terrestrial Network (NTN).

11. A User Equipment (UE), comprising:
a memory; and
a processor operatively coupled with the memory, wherein the processor is configured to execute program code to:
receive a measurement configuration comprising a combined triggering condition of a first triggering event and a second triggering event;
trigger a first measurement report in response to fulfilment of an entering condition of the first triggering event and an entering condition of the second triggering event; and
trigger a second measurement report in response to fulfilment of one of a leaving condition of the first triggering event, and a leaving condition of the second triggering event, if at least a first parameter for the first triggering event, or for the second triggering event, is set to TRUE.

12. The UE of claim 11, wherein the first triggering event is based on cell quality.

13. The UE of claim 11, wherein the second triggering event is based on UE location.

14. The UE of claim 11, wherein the first parameter is reportOnLeave.

15. The UE of claim 11, wherein the UE receives the first parameter for the first triggering event and does not receive the first parameter for the second triggering event in the measurement configuration.

16. The UE of claim 11, wherein the UE receives the first parameter for the first triggering event and the first parameter for the second triggering event in the measurement configuration.

17. The UE of claim 11, wherein the UE considers the first parameter for the combined triggering condition as TRUE if the first parameter for one of the first triggering event or the second triggering event is set to TRUE.

18. The UE of claim 11, wherein the UE applies the first parameter for the first triggering event as the first parameter for the combined triggering condition.

19. The UE of claim 11, wherein the UE does not trigger a third measurement report in response to fulfilment of the entering condition of the first triggering event or the second triggering event.

20. The UE of claim 11, wherein the UE is in a Non-Terrestrial Network (NTN).
